(19) United States
(12) Patent Application Publication
(10) Pub. No.: US 2013/0038727 A1
(43) Pub. Date: Feb. 14, 2013

(54) Cell Image Capturing and Remote Monitoring Systems

(71) Applicant: Phillip Clark, Wakefield, MA (US)

(72) Inventor: Phillip Clark, Wakefield, MA (US)

(21) Appl. No.: 13/574,463

(22) PCT Filed: Jan. 20, 2011
(86) PCT No.: PCT/US11/00111

§ 371 Date: Oct. 12, 2012

Related U.S. Application Data
(60) Provisional application No. 61/336,275, filed on Jan. 20, 2010.

(51) Int. Cl. H04N 7/18

(52) U.S. Cl. 348/143; 348/E07.085

(57) ABSTRACT

The present invention provides a cell culture data and cell image capturing and remote monitoring system that includes an imaging sensor pod having one or more cameras to capture multiple color still and/or motion images of cell cultures and cells located on a support and/or in a liquid located in a culture vessel within an incubator. The images can be taken at varying magnifications, and from different discrete locations on the support or in the vessel round the clock. The captured data and images are wirelessly transmitted to a management control unit, and/or another wirelessly connected and remotely located data transmission device such as PDA, for a researcher to review and analyze to determine the health and viability of cells, and the status of the cell culture. The image capturing and remote monitoring system taught herein alleviates the need for a researcher to be in the physical presence of a biological sample in order to visually ascertain and analyze the health and viability of the sample and status of the cell culture.

### FIELD OF THE INVENTION

The present invention relates to a system for remotely monitoring the health and viability of cells and the status of a cell culture. More particularly, it relates to a cell culture data and cell image capturing and monitoring system for remotely accessing cell images and cell culture data using one or more sensor pods to capture and transmit cell images and cell culture data, thereby allowing the remote visual determination of the health and viability of the cells without being in the physical presence of the cells.

### BACKGROUND OF THE INVENTION

Cell cultures have been utilized for many years in life science and biopharmaceutical research and manufacturing. Cells are typically grown on disposable plastic vessels, such as dishes or flasks, and placed in CO₂ incubators. Quite often, these vessels are used to propagate or maintain cells, and/or prepare cells for assays conducted outside of the incubator. In the end, these cell culturing methods are very labor-intensive and time consuming, especially when a large number of studies need to be performed.

Cell culture systems depend on controlled environments for cell maintenance, growth, expansion, and testing. Despite often taking stringent measures to avoid outbreaks of contamination and the like, e.g., fungus or bacterial contamination, such outbreaks still occur, often with the impact of compromising weeks of research and halting operations for days or weeks. At the very least, results of cell culture assays can be distorted by unintended changes in cell physiology due to inconsistencies in the underlying cell culture. Researchers must be ever vigilant in monitoring and evaluating cell health by visually observing subtle changes in cell morphology, growth patterns, and growth rates that may signal problems with a particular culture.

Researchers that grow mammalian cells often find the maintenance of cell cultures to be a very time consuming task. Actions such as visually assessing the health of cells by determining cell morphology under a microscope, replacing media (feed), recovering the cells (confluency), dealing with contaminants, monitoring metabolites or cell interactions, and other issues must be carefully addressed.

Unfortunately, in the modern laboratory environment, there are many impediments to the proper monitoring of cultured cells. For example, it may be impractical and cost prohibitive to conduct around-the-clock (e.g., every 2-4 hours) manual examination of cell cultures. Additionally, manually monitoring cell cultures round-the-clock often takes a physical and mental toll on researchers, resulting in an overall diminished quality of life, and increasing the likelihood of an observational error due to excessive fatigue. Furthermore, fully automated cell culture monitoring systems are excessively cumbersome and complicated, and require the investment of large sums of money.

In addition, simple visual examination of cells provides only a subjective assessment, with no lasting visual record or archive. Signs of problems with cells and cell cultures can be missed, leading to serious deleterious impacts on the quality of data generated by cell-based assays. The ability to supply healthy living cell cultures is an ever growing problem in today's competitive multinational biological and biopharmaceutical industries.

It should therefore be appreciated that within the bioprocess industry, research institutions, and pharmaceutical discovery companies, there is a need for a cell image capture and remote monitoring system that will allow a researcher to remotely observe, modify and maintain biological samples and cell cultures, without requiring the end user to be physically on site in the presence of the cell cultures in order to visually assess the health and viability of the cells.

Thus, what is needed is a cell culture data and cell image capture and remote monitoring system that provides the ability to remotely check the health and viability of cells, and the status of the cell culture, from any location. The systems taught herein improve the quality and efficiency of research and cell production, as well as provide a cost efficient, flexible, easy to use, and time saving remote cell image capturing and monitoring system that provides real-time information on the health and viability of the cells and the status of the cell culture, without the researcher having to be in the physical presence of the cells.

### SUMMARY OF THE INVENTION

The present invention provides a cell culture data and cell image capturing and remote monitoring system for remotely viewing, monitoring, analyzing, reporting and storing cell culture data. The capturing and remote monitoring system taught herein enables a researcher to determine the health and viability of cells located on a support and/or in a solution in a culture vessel, without requiring the researcher to be on-site, in the physical presence of the cells, in order to visually assess the cell culture status, and the health of the cells.

In other embodiments, the cell culture data and cell image capturing and remote monitoring system according to the present invention comprises one or more water tight imaging sensor pods, powered by rechargeable batteries, and having, therein one or more imaging sensors, such as an imaging technology like a camera or the like, capable of capturing multiple color images. Preferably, the imaging technology captures two or more still and/or motion digital color images, taken from at least two discrete positions within the culture vessel or on the support.

In some embodiments, the data and image capturing and remote monitoring system according to the present invention includes an imaging sensor having a minimum image magnification capabilities from about of 10× to about 250×, and an auto focus capability with optional user manual focus control. The imaging sensor includes multiple fixed cameras and/or one or more moveable cameras on a pod having a drive mechanism positioning system. The one or more imaging sensors also includes one or more cameras used in combination with a microscope and/or an inverted microscope.

In one embodiment, the capturing and remote monitoring system includes one or more imaging sensor pods that are coupled to a culture vessel located in an incubator. Alternatively, the pod can be coupled or docked to the incubator, or both the incubator and the culture vessel. The cell culture data and cell image capturing and remote monitoring system includes a database management system, including a computer and software for (1) addressing the pod to upload and download images, data and information on the health and viability of the cells, and status of the cell culture; (2) storing and analyzing still and/or motion images of the cells, and cell culture data, (3) providing measurements and the necessary details to facilitate decision making, and (4) providing operational control over the pod, culture vessel, support and incubator to carry out instructions, either automatically or upon a users intervention, to carry out recommended cell culture process operations needed to maintain the health and viability of the cells and cell culture.

In another embodiment, the capturing and remote monitoring system according to the present invention provides wireless connectivity for sending alerts, still and/or motion images to a data transmission device, computer, mobile communication device, or any other such device, or web based system and/or server.

It is another object of the present invention to promote the health and viability of cells in a culture vessel placed in an incubator, by diminishing fluctuations in incubator conditions which occur upon each opening of the incubator in order to inspect the culture vessel, as well as diminishes undesirable disturbances to the cells which can occur when moving culture vessels to a microscope to examine the health and viability of the cells. Each time the cells in the culture vessel leaves the incubator, the risk of contamination increases.

In some embodiments, the capturing and remote monitoring system according to the present invention automatically (1) determines which actions need to be taken to maintain an appropriate cell culture environment, and promote the health and viability of the cells therein, and (2) automatically transmits information, instructions and required actions that need to be taken to a an authorized end user's data transmission device, computer, or web based system and/or server.

In other embodiments, the capturing and remote monitoring system according to the present invention comprises one or more water tight imaging sensor pods coupled to a culture vessel or support located in an incubator. The pods are preferably connected to a computer or other data transmission device, in a wireless format, wherein the computer other data transmission device can (1) address each pod individually, (2) download actionable commands to each pod, and (3) upload still images, motion images, cell image and cell image and/or sensor data from each pod. The images can be processed by computer or web based software tools such as by interrogating the images with software for color comparisons as an indicator of pH shifting, or interrogating the images with standard machine vision tools such as blob analysis and edge detection to look at the status of growth as an indicator of overall growth or confluency; and/or assessing the morphology of the cells as an indicator of cell health.

Imaging tools such as blob analysis and edge detection are used to compare the relative relationship as the pixel level. A blob tool buckets the image pixels in a binary format. Once bucketed the shape of the defined blobs can be analyzed for shape, shape center of area, etc. Edge detection uses a change in the pixel intensity to define a boundary edge. Usually, a steep change in the intensity is used, but the user can adjust the gain for edge detection. Once an edge is found, again the shape can be analyzed. Shape comparisons can be made whether to other called shapes or to expected shapes or to a libraries of shapes.

In yet further embodiments, the capturing and remote monitoring system according to the present invention includes additional sensors, including but not limited to, sensors for detecting the temperature, pressure and humidity of the incubator, the status of a pod's battery level, pH levels, levels of dissolved gases such as nitrogen, oxygen, and carbon dioxide, glucose levels, glutamine levels, lactic acid levels, ammonia levels, the presence and quantity of metabolites, spectroscopy, and combinations thereof. Optionally, these sensors are read or imaged by the imaging sensor, whereby the images are transmitted to a local computer, other data transmission devices, or a web based server for analysis and storage, and/or directly transmitted to a researcher or other authorized end users for real time image retrieval, review, and analysis.

In some embodiments, the capturing and remote monitoring system according to the present invention comprises one or more imaging sensor pods having, in addition to wireless connectivity from the incubator to a local computer, data transmission device or web based server, contains an optional hardwired connection from the incubator and/or the local computer, data transmission device or web based server, while maintaining wireless capability.

In other embodiments, the capturing and remote monitoring system according to the present invention comprises an imaging sensor pod having a self contained light source, such as a ring light around a camera lens, and/or optionally a separate lighting source for backlighting the cells in a culture vessel, or on a support.

In various embodiments, the capturing and remote monitoring system according to the present invention provides the researcher with remote accessibility to one or more image capturing sensor pods, including remotely controlling the pods in order to ascertain, in real time, the status of the cell culture, and the health and viability of the cells through still color image capturing and/or motion color image capturing and streaming.

In certain embodiments, the capturing and remote monitoring system according to the present invention provides an image capturing sensor pod that reads RFID chips to ensure authentic products are in use, such as an authentic and approved culture vessel or support coupled to the pod. Software can limit the functionality of the system when non-authentic and non-approved culture vessels, and the like, are coupled to the pod.

Additional features and advantages of the invention will be set forth in the detailed description which follows. Many modifications and variations of this invention can be made without departing from its spirit and scope, as will be apparent to those skilled in the art. It is to be understood that both the foregoing general description and the following detailed description, the claims, as well as the appended drawings are exemplary and explanatory only, and are intended to provide an explanation of various embodiments of the present teachings. The specific embodiments described herein are offered by way of example only and are not meant to be limiting in any way.

### BRIEF DESCRIPTION OF THE DRAWINGS

In general, each of the FIGURES provide schematic representational illustrations of embodiments of the invention and its components. The relative location shapes, and/or sizes of objects are exaggerated and/or simplified to facilitate discussion and presentation herein.

FIG. 1 shows a schematic view of an exemplary cell culture data and cell image capturing and remote monitoring system in accordance with aspects of the present invention;

FIG. 2 shows a schematic view of an additional data and image capturing and remote monitoring system in accordance with aspects of the present invention;

FIG. 3 shows a schematic view of an additional data and image capturing and remote monitoring system in accordance with aspects of the present invention;

FIG. 4 shows a perspective view of an additional embodiment of the present invention;

FIG. 5 shows a schematic view of an additional aspect of the image capturing and remote monitoring system in accordance with the present invention;

FIG. 6 shows a schematic view of an additional aspect of the image capturing and remote monitoring system in accordance with the present invention;

FIG. 7 shows a schematic view of an additional aspect of the image capturing and remote monitoring system in accordance with the present invention; and

FIG. 8 shows a schematic view of an additional aspect of the image capturing and remote monitoring system in accordance with the present invention

### DETAILED DESCRIPTION OF THE PREFERRED EMBODIMENTS

Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible.

For the purposes of this specification and appended claims, unless otherwise indicated, all numbers expressing quantities of ingredients, percentages or proportions of materials, reaction conditions, and other numerical values used in the specification and claims, are to be understood as being modified in all instances by the term “about”.

Before describing the present invention in further detail, a number of terms will be defined. Use of these terms does not limit the scope of the invention but only serve to facilitate the description of the invention.

As used herein, the singular forms “a,” “an,” and “the” include plural referents unless the context clearly dictates otherwise.

As used herein the phrase, “biological samples” mean, but are not limited to, any particle(s), substance(s), extract(s), mixture, and/or assembly derived from or corresponding to one or more organisms, cells, and/or viruses. It will be apparent to one skilled in the art that cells which may be cultured in the automated cell management system comprise one or more cell types including, but not limited to, animal cells, insect cells, mammalian cells, human cells, transgenic cells, genetically engineered cells, transformed cells, cell lines, plant cells, anchorage-dependent cells, anchorage-independent cells, and other cells capable of being cultured in vitro as known in the art. The biological sample also may include additional components to facilitate analysis, such as fluid (e.g., water), buffer, culture nutrients, salt, other reagents, dyes, etc. Accordingly, the biological sample may include one or more cells disposed in a culture medium and/or another suitable fluid medium.

As used here the expression “confluency” refers to the measurement of the number (i.e., percent) of the cells covering a cell culture vessel, dish or the flask. The percent (%) of confluency can be determined by the following relationship:

% confluence=[(imaged area covered by cells)/(total area imaged)]×100.

As used herein the phrase, “culture vessel” or “container” means, but are not limited to, any petri-dishes, multi-well plates, microtiter plates, roller bottles, tanks, bioreactors, bags, and flasks including, screwcap flasks such a flasks having one or more layers of cell growth surfaces as taught in United States Patent Application Publication No. 2010/0129900, titled Layered Flask Cell Culture System, which is fully incorporated herein by reference. Typically, such culture vessels are for single-use and are manufactured from polymeric materials, such as fluoropolymers, high density polypropylene (HDPE) and specially-treated polystyrene plastic that are typically supplied sterile and are disposable.

As used herein the phrase, “cell culture” means, but is not limited to, growth, maintenance, transfection, or propagation of cells, tissues, or their products.

As used herein the phrase “culture medium” as used herein means a liquid solution used to provide nutrients (e.g., vitamins, amino acids, essential nutrients, salts, and the like) and properties (e.g., similarity, buffering) to maintain living cells (or living cells in a tissue) and support their growth. Commercially available tissue culture medium is known to those skilled in the art. The phrase, “cell culture medium” as used herein means tissue culture medium that has been incubated with cultured cells in forming a cell culture; and more preferably refers to tissue culture medium that further comprises substances secreted, excreted or released by cultured cells, or other compositional and/or physical changes that occur in the medium resulting from culturing the cells in the presence of the tissue culture medium.

As used herein the phrase “cell culture process operation” includes but is not limited to operations carried out on the cell culture based upon determination of the culture state of the cells from the acquired images and/or data. Examples of such operations include i) controlling the volume, concentration, and composition levels of media and nutrients in the culture device, ii) sampling, lifting, and recovering the cells from the culture device, and iii) splitting and plating cells into additional culture devices.

As used herein the term “lifting” refers to the process of disassociating cells from the culture device surface and collecting the cells. A common method of lifting includes the use enzymes to digest attachment proteins, thereby freeing the cells from the surface the cells are growing and attached thereto.

As used herein the term “splitting” is the process of taking cells collected from the culture device, diluting the cells, and transferring the diluted cells into a different flask or vessel. The seeding density of the cell typically results in a confluency of 5% to 50%, and most times the initial confluency is closer to 10×.

As used herein the phrase, “database management and control system” means, but are not limited to, a computer-software-based management system for receiving, processing, analyzing, and storing each pod's sensor data and images to determine if the detected parameters of the cells and cell cultures are within desired norms, detect deviations or abnormalities in the detected parameters, determine the mode of action in response to an analysis of the detected parameters or any other analysis and processing of the data necessary in the evaluation of the cells and cell cultures. Appropriate control instructions in response to the processed data may be transmitted back to the pod, incubator, culture vessel, authorized personal data transmission device, computer and/or web based system through a physical hard copy such as on a CD, DVD, magnetic tape, or even paper, or a wireless, hard-wired or computer-based communication means, network, or other system means. The database management and control system is able to transmit and/or receive communication via wireless transmissions and/or transmissions carried by a hard wired connection.

As used herein the phrase “data transmission device” means, but is not limited to personal digital assistant (PDA), cell phones, pagers, computers with wireless and/or hardwire capability, or any other devices capable of wireless and/or hard wire data transmission or receiving information or instructions.

As used herein the phrase “data and image capture system” means, but is not limited to, techniques using film-based methods, techniques using digital methods and techniques using any other methods for data and image capture. The cell culture data and image capture system further comprises methods that record data and an image as a set of electronic signals. Such an image can exist, for example, in a computer system However, cell culture data and cell images can be captured on film, on magnetic tape as video or in digital format as well. Cell culture data and cell images captured using analog technologies can be converted to digital signals and captured in digital format. Cell images, once captured, can be further manipulated using photo manipulative software. An image once captured can be displayed for an authorized end user using a variety of media, including paper, CD-ROM, floppy disc, other disc storage systems, or web based over the internet. The term “recording” as used herein refers to any data and image capture, whether permanent or temporary. A data and image capture system further includes those technologies that record moving images, whether using film-based methods, videotape, digital methods or any other methods for capturing a moving image. The cell culture data and image capture system further includes technologies that permit capture of a still image from moving images. An image, as the term is used herein, can include more than one image. Video can be immediately transmitted to the database management and control system device in streaming video format so that the video is viewable on a data transmission device or over a web based network in real time.

As used herein the term “incubator” means, but is not limited to, an incubating device located in a laboratory, a manufacturing facility, or any clinical or other setting in which cell culture via incubation is desired. The incubator preferably maintains a controlled environment from about 5% CO₂ to about 20% O₂, and controlled temperature, although any environment may be used and selected by one of ordinary skill depending on the particular end use application, given the teachings herein. The incubator environment may be separately controlled, or controlled by an external PC or other controller device, either automatically or in response to commands provided by a pod, researcher and/or other authorized end user.

As used herein the phrase “remotely located” means not in the physical presence, such as not located on the site of the biological sample(s) and/or culture device or support of interest.

As used herein the term “sensor” means, but is not limited to, mechanical, electrical or optical sensing devices that measure information such as physiologically relevant information (e.g., temperature, humidity, pressure, pH, biochemicals, biomolecules, gases such as CO₂, and other chemical parameters, enzyme-based parameters, radiation, magnetic and other physical parameters), or other information or parameters such as spectroscopy.

As used herein the term “wireless” means, but is not limited to, radio frequency, acoustic or optical means for transmitting and receiving information. Wireless connections also include short-range wireless connections on the order of a few feet, such as a Bluetooth® type wireless connection, or a medium range wireless connection on the order of about 100 feet, such as a WIFI™ connection.

The present invention encompasses a cell culture data and cell image capturing and remote monitoring system having an imaging sensor pod for capturing and transmitting cell culture data and cell images to an image and data receiving and management control unit, and an image and data receiving and display control unit. The pod, management control unit, and display control unit each preferably have wireless transmit/receive communication capability. In other embodiments taught herein, cells and cell cultures are located on a substrate and/or in a culture vessel located in an incubator. The pod preferably has wireless transmit/receive communication capability to the substrate, culture vessel, and incubator as well. The imaging sensor pod preferably includes an imaging technology such as a CCD or CMOS camera, a CCD or CMOS video camera, or combinations thereof, and one or more sensors including but not limited to a pH sensor, temperature sensor, humidity sensor, pressure sensor, glucose sensor, oxygen sensor, carbon dioxide sensor, glutamine sensor, lactic acid sensor, ammonia sensor, nitrogen sensor, spectroscopy sensor, and combinations thereof. The display control unit can be a monitor, LCD screen or the like which may include an interface through which a user can input some data. The pod can be powered by various power delivery and power supplies well known in the art such as by battery power, Universal Serial Bus (USB) power, line power or hardwired power and combinations thereof. Alternatively, the pod data receiving and management control unit, as well as the image and data receiving and display control unit can each be integral with an incubator, or any other environmentally controlled chamber, management control unit.

The cell culture data and cell image capture and remote monitoring system taught herein enables one to visually determine the status of the cell culture, and the health and viability of cells located on a support and/or in a solution in a culture vessel and present in an incubator, without requiring one to be on-site in the physical presence of the cells and cell culture.

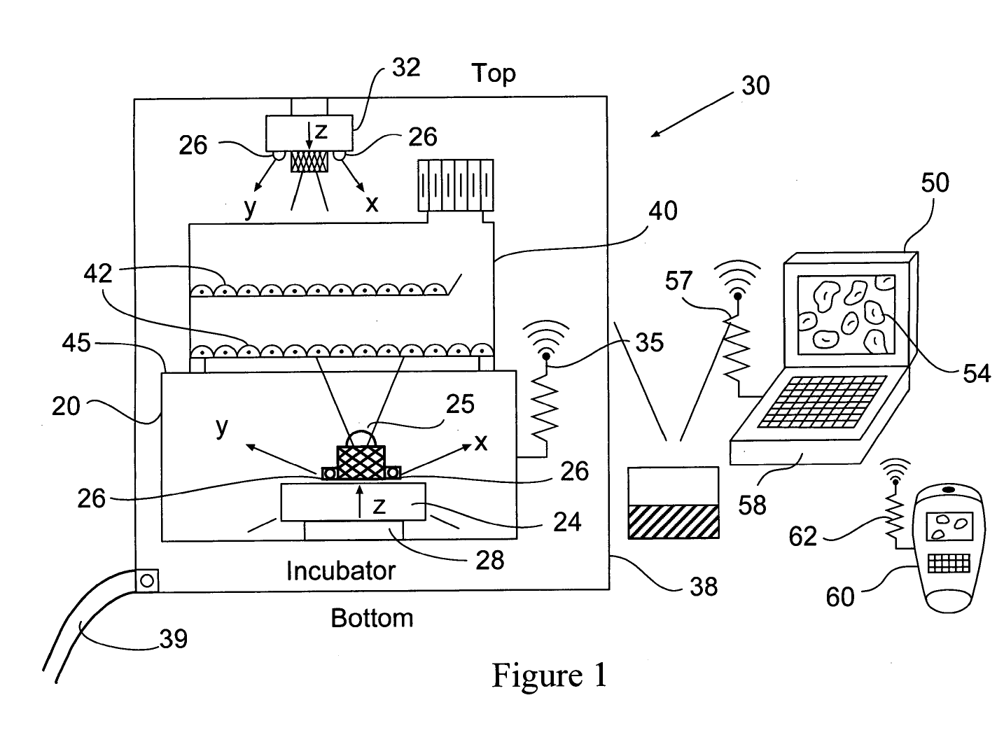

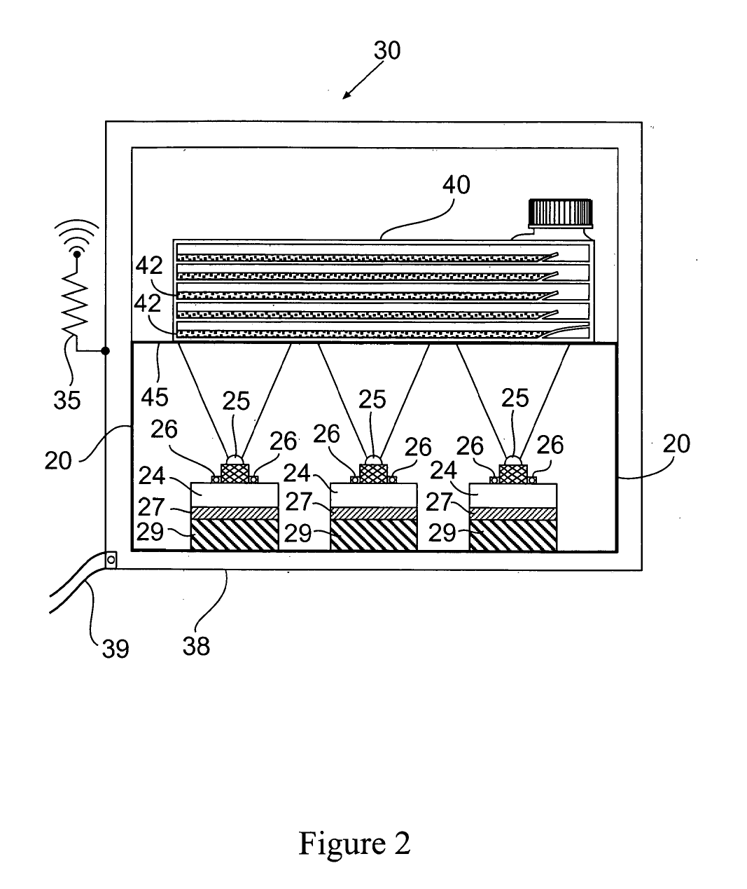

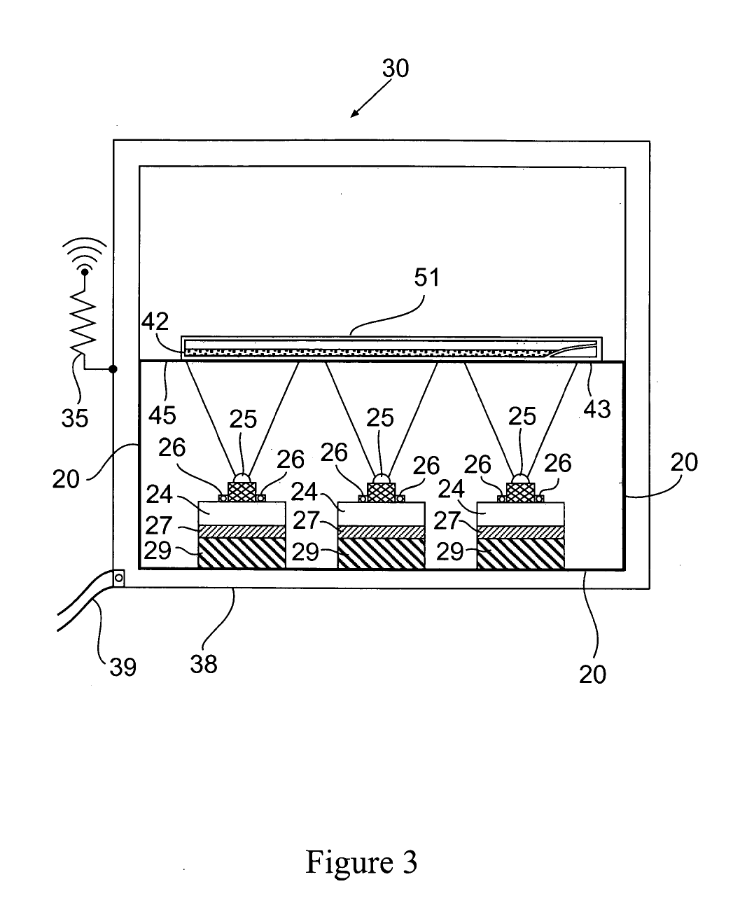

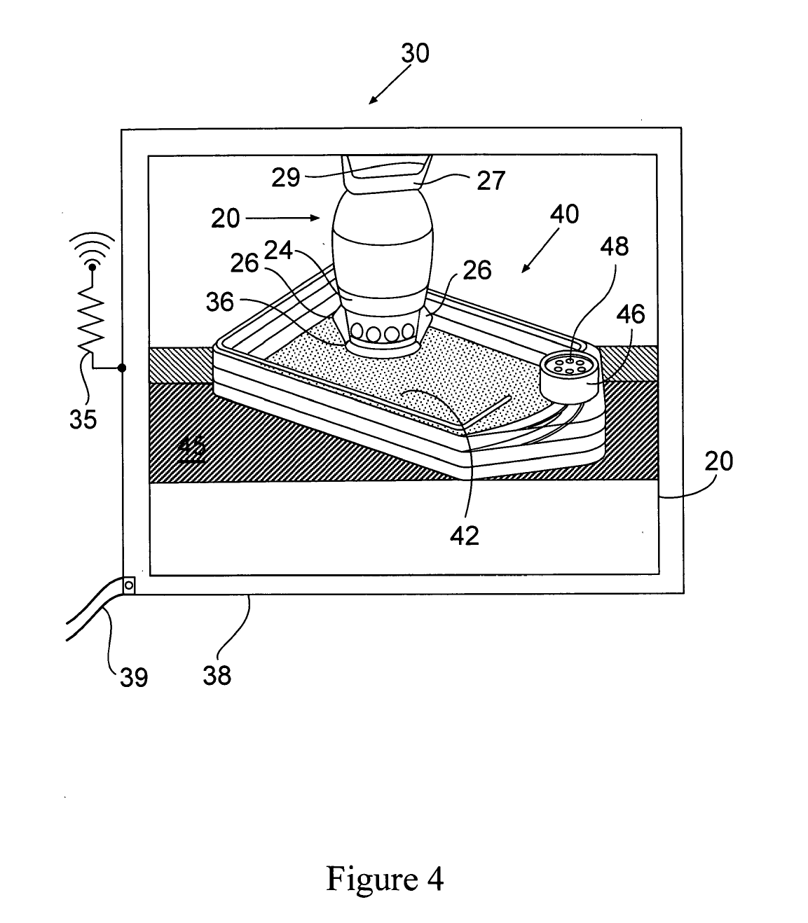

FIGS. 1-8 show schematic representations of exemplary cell culture data and cell imaging and monitoring systems 30. The present invention teaches a remotely accessible cell culture data and cell image capturing and monitoring system 30 having one or more imaging and data sensor pods 20 having an upper or top support surface 45, and a database management control unit 58, such as a computer (PC), that operates the pods 20 both automatically and in accordance with instructions provided by an authorized end user.

The pods 20 are configured to operate in an environmentally controlled chamber, such as inside a biological sample culture incubator 38. Accordingly, pods 20 preferably have a compact design to minimize their size while maintaining their image sampling and other sensor capacities. This compact design can be facilitated by various features, such as an optical detection mechanism 24 having a self-adjusting and operator controlled optical detection mechanism having a range of magnifications.

Imaging and data sensor pods 20 capture information from biological samples 42 on a support or within culture vessels 40, such as when the biological samples are in a culture vessel 40 or on a support 43 which is preferably located on the top or upper support surface 45 of the pod 20. Both the pod 20 and the culture vessel 40 or support containing the biological samples 42 are placed in an incubator 38 or the like. The upper or top support surface 45 of the pod 20 that the culture devices or vessels 40 are positioned on and imaged through is preferably clear, transparent glass or plastic.

Alternatively, the cell culture device or vessels 40 can be supported by an open frame pod (not shown) so that the optical detection mechanism 24 or camera is imaging directly into the culture device or vessel 40 without any potential distortion of the glass or plastic upper support surface 45 of the pod 20. The open frame can also include alignment features to accurately position the cell culture device such that images are taken of the same cell culture area over time in order to monitor the progress of a cell population or other biological samples.

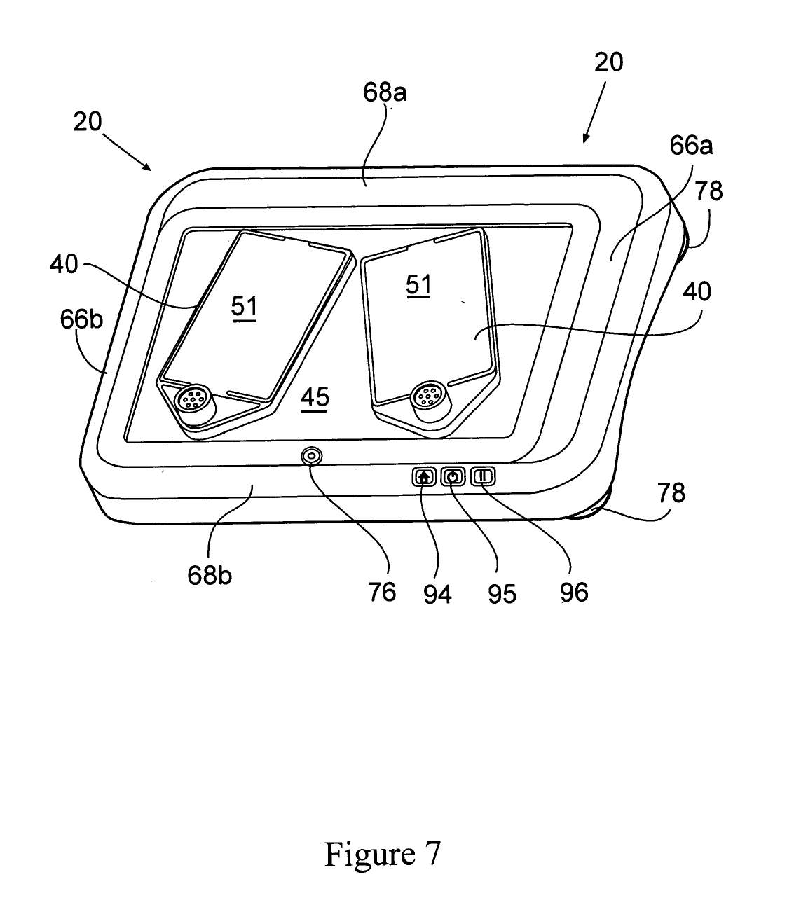

In embodiment of the invention as provided and depicted in FIG. 7 the top or upper surface support 45 of the pod 20 is adjustably segmented and contains raised edges or ridges properly sized to receive a culture vessel 40 containing the biological samples 42 such that the vessels are positioned on the top support surface 45 of the pod 20 in a predetermined x-y axis position for accurate imaging and data collection.

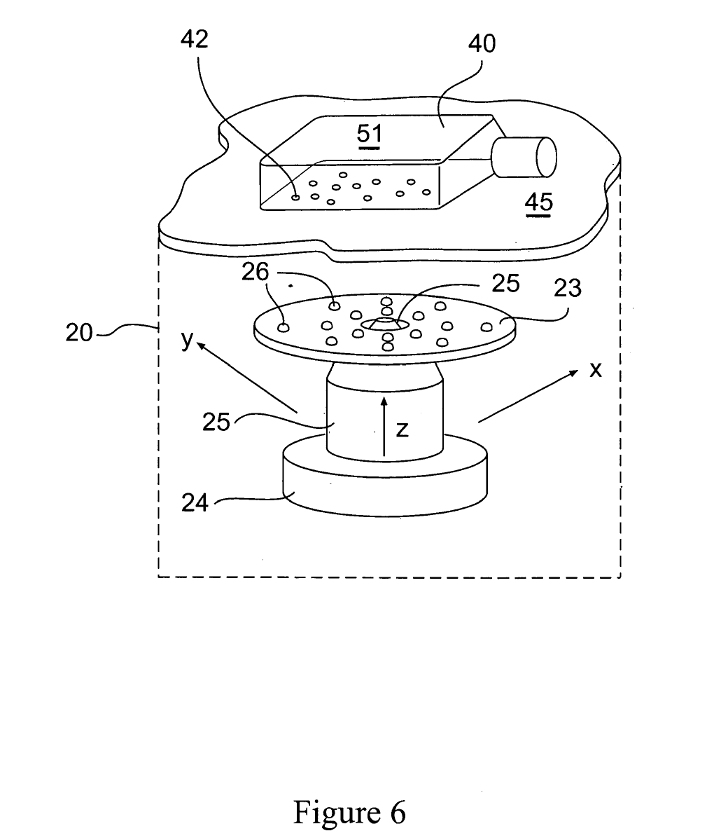

As depicted in FIGS. 6-8, the culture vessel 40 is a flask, such as those taught in United States Patent Application Publication No. 2010/0129900, having a top or upper side 51.

In certain embodiments, the database management control unit 50 is preferable in wireless data signal communication, and/or optionally a hard wired connection cable 39 or the like, to a network (such as a local area network (LAN) or wide area network (WAN)), so that an authorized user may interact with the database management control unit 58 remotely through an interface such as a graphical interface, and/or from a wirelessly 62 connected data transmission device 60. The display unit may be a monitor 50 which includes an interface through which a user can input data, manipulate the captured images and data, or the like.

The cell imaging systems 30 taught herein offer a number of advantages and improvements over current cell culture observation techniques, such as by alleviating the need for a researcher's physical presence in monitoring cell cultures, while enabling remotely accessible in-situ real-time observation and analysis of cells and cell cultures contained in an incubator.

Cells 42 growing in culture vessel 40, such as those depicted in FIGS. 1-8, need to be routinely accessed by a researcher to determine the status of cell culture and cell growth, health and viability, and to determine which steps should be taken, such as when cells are near confluent whereby the researcher detaches the cells from the culture vessel for use in assays, screens or the like, or to reseed new cell culture systems to continue to expand the cell line. It is important to recover the cells prior to 100% confluency.

The cell image capturing system 30 taught herein permit a researcher to remotely view an unattended cell culture through an imaging sensor such as a camera 24 having zoom lens magnification capability and/or a microscope to investigate cell 42 growth and culture status without moving the culture vessel 40. It is desirable to be able to fill the culture device with the appropriate amount of media and additives needed to satisfy the needs of the cell type, as well as the researcher's work schedule. An advantage of the cell imaging system 30 taught herein is that it enables the remote viewing of images of the cells 42 without having to transport the culture vessel 40 or support to a microscope.

The pod 20 includes one or more cameras 24 for observing biological samples 42 housed in the culture vessel 40, wherein the pods 20 are preferably arranged below the samples 42, such that cameras 24 take images 54 of the samples 42. Imaging sensor pods 20 may also be arranged above biological samples 42, as depicted in FIG. 1.

Camera 24 functions such that captured cell images 54 are still or motion color images, and are preferably wirelessly 35 transmitted to the database management control unit 58, or transmitted by hard wired connection 39. Camera 24 is preferably a CCD (charge coupled device) such as CCD camera or a CMOS (complementary metal oxide semiconductor) image sensor such as a CMOS camera capable of capturing multiple color images, preferably three or more still or motion color images taken from at least three discrete positions within the culture vessel. In addition, the camera 24 can capture an image of the entire vessel or support.

CCD or CMOS camera additionally acquires multiple still or motion images of the cells growth in a flask from multiple different positions under magnification from about 10× to about 250×, with the preferred magnification ranges being from about 10× to about 100×, as well as 40× to about 100×.

The data transmission device 58 preferably includes, i) image processing software for analyzing the cell culture data and cell images captured by the camera 24, ii) operational control software for determining the culture state (proliferation capability and proliferation ability of the cells) of the cells from the images of the cells acquired by the CCD or CMOS camera, and providing instructions such that an appropriate culture process operation are carried out on the basis of the determination made by the data transmission device 58 as a result of analyzing the captured cell culture data and cell images.

The imaging sensor pod 20 also preferably contains a device for projecting light within the flask or onto a the support so that cell images captured and recorded are appropriately lit from the front, back, or both as determined by either an authorized user or automatically determined by data transmission device 58.

Camera 24 preferably has lens 25 with image magnification capabilities from about 10× to about 250×, with a preferred minimum magnification of 10× to about 100×, and an auto focus capability with optional remote user control. The imaging sensor pod 20 preferably includes multiple fixed cameras 24 and/or one moveable camera located on a drive mechanism positioning system. Imaging sensor pod 20 can also include a camera used in combination with a microscope. (not shown)

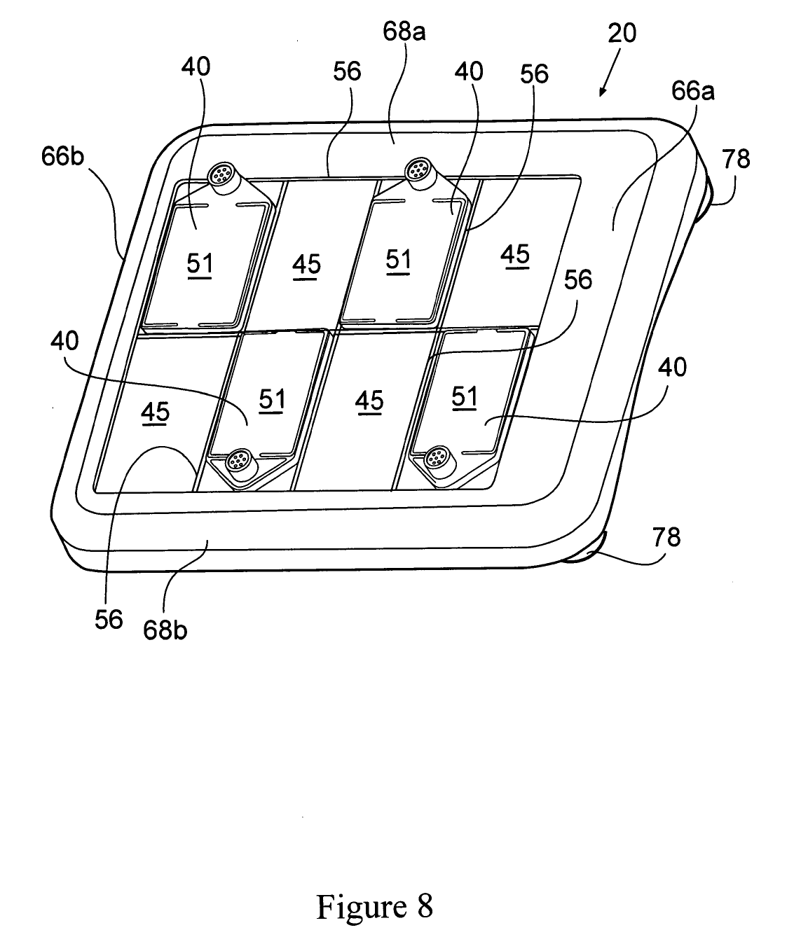

As depicted in FIGS. 7 and 8, one embodiment of the invention as provided herein includes pod 20 having, by way of example only, two side walls (66a, 68a) that are wider than the opposing sides walls (66b, 68b) in order to facilitate a drive mechanism positioning system having X and Y axis rails and drive motors housed under the two wider side walls (66a, 68a) of the pod.

Observation of the cell samples include projecting a light from a light source 26 located on the imaging sensor pod 20 into the vessel 40 to illuminate the cell samples 42, and aide in the capturing of cell culture data and cell images 54. The cell culture data and images are analyzed, preferably in real time, such as with image recognition and analysis software. For instance, such information can be used to control one or more process conditions within the culture vessel 40. In a preferred embodiment as provided herein the camera 24 and lighting source 26 move together or are capable of moving together within the pod.

FIG. 6, depicts another embodiment of the invention as provided herein is wherein the camera magnification lens 25 is surrounded by LEDs 26, preferably arranged as an array of LEDs 23. As depicted in FIG. 6, the LED array 23 surrounds the lens 25 in order to provide a light source capable of sufficiently illuminating the cell samples 42 in vessel 40. The LEDs 26 and LED array 23 are preferably “addressable” and adjustable with regards to power, brightness, illumination, intensity, color and dimming. As used herein the term “addressable” means the pattern of light provided by the LED array 23 can be adjusted or addressed. For example, the LED array 23 can be adjusted such that only specific LEDs 26 of the array are on whereby only right side or right edge of the cell samples 42 in vessel 40 is illuminated while the left side or edge of the cell samples 42 in vessel 40 is kept in darkness in order to provide a shadowing effect so as to enhance edge detail or surface features the cell samples 42 in vessel 40 which may otherwise not be visualized without this desired shadowing effect.

Preferably, imaging sensor pod 20 is a fully automated imaging system designed to fit inside a standard cell culture incubator 30. This arrangement permits around-the-clock imaging of the cell culture and cells without removing the culture vessel or support from the controlled environment, and permits pod 20 to gather continuous time-lapsed images. Additionally, the use of a software interface allows for viewing still and/or motion digital images and image metrics remotely.

Preferably, the remotely accessible sensor pod 20 is designed such that users program the pod 20 to acquire still and/or motion images at different spatial locations and time points via a network-accessible graphical user interface, such that the cameras automatically focuses on each spatial location and acquire successive images automatically, and around-the-clock. Once the still and/or motion images are collected, custom image processing and recognition software calculates and graphs a variety of application-based image metrics include, for example the size of the cells, the size of cells versus volume, the mean diameter of the cells, the surface area particles, the flow rate of the cells, the flow pattern of the cells the population distribution of the cells, cell viability, the presence of agglomerates or clumping, the color change of cells, temperature and viscosity of the process liquid, and the like. This information can be used as a control tool to implement changes to process operating parameters in real time.

The remotely accessible sensor pod 20 is useful for imaging a range of parameters, either automated or in response to a user's guidance. The pod can be used in the automated collection of cell culture data and cell images, and provides a method to digitally capture and archive cell growth and morphology in real-time.

Preferably, the camera(s) recording the still and/or motion images of cells are housed within a hermetically sealed protective shroud. Image capturing sensor pod 20 includes one or a plurality of lenses, or windows, through which images are recorded by the camera 24 and carries a means for projecting light within the vessel so that images recorded by the camera are front lit, back lit, or both. The pod 20 transmits the camera's 24 information of the recorded images to a data transmission device computer 58 or like processor on which the image recognition software is loaded. In one embodiment, the image is compressed, for example into a Joint Photographic Experts Group (JPEG) standard format by data transmission device 58. Other file formats for the images can also be used, such as by way of example, TIFF (Tagged Image File Format), BMP (Windows Bitmap Image File), DIB (Device Independent Bitmap) file format, GIF (Graphics Interchange Format), PNG (Portable Network Graphics) image format, or other digital image files and formats known in the art.

The cell culture and cell image capturing sensor pod 20 preferably comprises a CCD or CMOS camera for imaging the cell culture data and cells in the cell culture apparatus. The CCD or CMOS camera mechanism can also be connected to a microscope mechanism such that the camera takes images of the cells through the microscope mechanism. The CCD or CMOS camera mechanism is connected to the computer.

In one embodiment, the invention is directed to enabling a researcher to remotely access and control CCD or CMOS imaging technology in real-time (˜1 Gbps) using data transfer throughput. The remote control CCD or CMOS imaging technology can be connected to a local server such that the researcher using any web browser that supports the software can access it. Any authorized internet user can control the CCD or CMOS imaging technology. As depicted in FIG. 1, a remote user can control the movement of the CCD or CMOS imaging technology in X-Y axes, and light emission, control focus and or magnification in Z axis, and process theses images.

Additionally, a microscope-based live video streaming system (cellular observatory) can be implemented to enable cell image viewing, analysis and instructions.

The imaging mechanism transfers information of the recorded images to a computer or like processor on which the image recognition software is loaded. The images can also analyze in real time, with image recognition and analysis software. For instance, the software measures mean diameter, surface cell viability, color change, temperature, viscosity, and the like. Such information can be used to remotely control the process conditions in the one or more sealed vessels. Images are downloaded from the image capture devices to a shared storage location. In this specification, an “image” refers to a still image or a moving image.

In addition, the imaging mechanism carries a means for projecting a light source, such as a LED (light-emitting diode) illuminator within the vessel so that images recorded by the camera are front lit, back lit, or both. The imaging mechanism transfers information of the recorded images to a computer or web based network on which the image recognition software is loaded. The images can also be analyzed in real time, with image recognition and analysis software. For instance, the software measures mean diameter, surface area, flow rate, flow pattern, population distribution, cell viability, agglomerates or clumping, color change, temperature, viscosity, and the like. Such information can be used to remotely control the process conditions in the one or more sealed vessels.

One manner in which the pH of the media and cell culture can be visually determined and captured by the imaging mechanism is by determining the color of the media and cell culture in the presence pH indicator. In a preferred embodiment of the invention, the media contains a solution of phenol red (also known as phenolsulfonphthalein or PSP) for use as an indicator of the pH of the media. The phenol red changes from red to yellow as the pH value of the media decreases (i.e., becomes more acidic). Phenol red exhibits a gradual transition from red to yellow over the pH range of about 8.2 to about 6.8. When the pH of the media is above pH 8.2, phenol red turns a bright pink color.

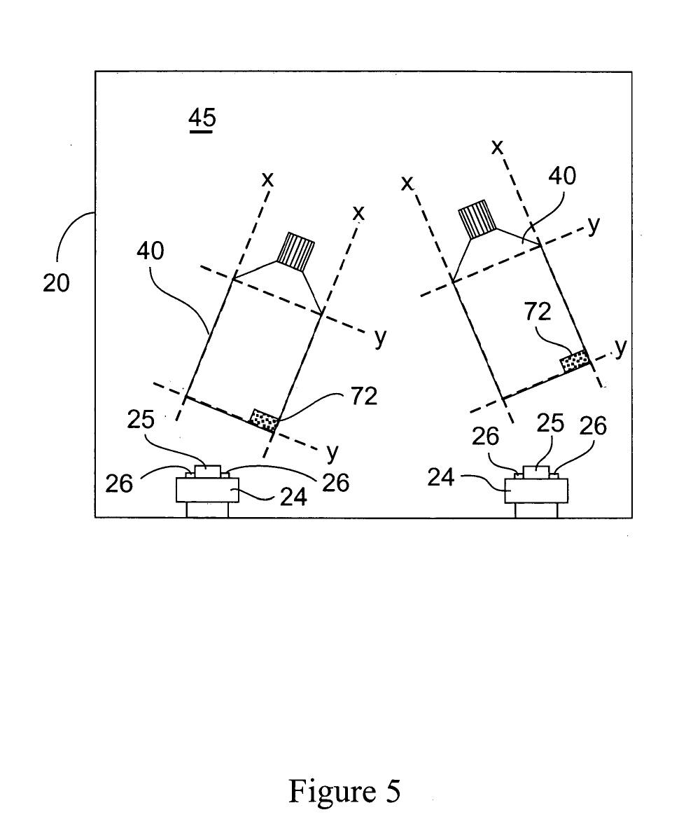

FIG. 5 schematically depicts two cell culture flasks 40 positioned on the upper support surface 45 of pod 20. The pod's imaging system 24 first scans the surface of the flask 40 identifying the authorization code information 72. The authorization code information 72 for each cell culture vessel 40 would include dimension parameters such as the size, shape, volume, and the like of each cell culture vessel, as well as specific tracking identification indicia unique to each vessel. Using a pattern tool, the imaging system 24 defines X and Y coordinates that define the culture area within each flask 40 to be analyzed.

FIG. 7 schematically depicts two cell culture flasks 40 positioned on the upper support surface 45 of a pod 20. The figure also depicts a leveling control unit 76 for leveling the pod, such as by adjusting the height of leveling feet 78 provided beneath the pod. FIG. 7 also depicts examples of local controls that can be incorporated into the pod such as a “Home”, “Power On” and “Park” buttons or images. (94, 95, 96)

The cell image capture and monitoring system for remotely retrieving cell images from an unattended culture vessel or support located within an incubator or the like as taught herein offer improved sample handling, real time remote access in-situ observation, remote control of sample monitoring, remote access to sample data, and/or non-invasive inspection, among others. Moreover, cell image capturing and monitoring systems taught herein may provide a convenient approach for generating microscopic imagery of a plurality biological samples over longer time periods (hours to days), without having to remove the samples from a controlled environment (incubator) and/or without the need for human intervention.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

What is claimed:

1. A cell culture data and cell image capturing and remote monitoring system comprising:
a) an imaging sensor pod adapted to capture and transmit cell data and cell images;
b) a management control unit adapted to receive the transmitted cell data and cell images; and
c) a display control unit for viewing the cell data and cell images.

2. The system according to claim 1, wherein the cells are located on a support or in a solution located within a culture vessel.

3. The system according to claim 2, wherein the pod and the culture vessel are situated in an incubation unit.

4. The system according to claim 1, wherein the pod is further adapted to wirelessly transmit the cell data and an cell images and the management control unit is further adapted to wirelessly receive the transmitted data and images.

5. The system according to claim 1, wherein the management control unit is further adapted to store and analyze the transmitted cell data and an cell images.

6. The system according to claim 2, wherein the pod comprises a camera for capturing the cell images, and the pod is adapted to move the camera such that the camera captures cell images from two or more distinct regions on the support or in the culture vessel.

7. The system according to claim 2, comprising two or more pods, each pod having a camera adapted to capture color still images, color motion images, and combinations thereof, from distinct regions on the support or in the culture vessel.

8. The system according to claim 1, wherein the pod further comprises a sensor from the group consisting of a pH sensor, temperature sensor, humidity sensor, pressure sensor, glucose sensor, oxygen sensor, carbon dioxide sensor, glutamine sensor, lactic acid sensor, ammonia sensor, nitrogen sensor, spectroscopy sensor, and combinations thereof.

9. The system according to claim 1, wherein the pod further comprises a light source.

10. The system according to claim 9 wherein the light source is a LED array.

11. The system according to claim 9 wherein the light source is an array of LEDs, wherein the color, illumination, brightness, intensity and dimming of each LED in the array is selectively controlled.

12. The system of claim 2, wherein the pod is adapted to capture a color image with a magnification from about 10× to about 250×, from distinct regions on the support or in the culture vessel.

13. The system of claim 2, wherein the pod is adapted to capture a color image with a magnification from about 40× to about 100×, from distinct regions on the support or in the culture vessel.

14. The system of claim 8, wherein the camera is selected from the group of a CCD camera, CMOS camera, CCD video camera, CMOS video camera, and combinations thereof, and the camera is adapted to a focus capability from the group including auto focus capability, user controlled electrical focus, user control manual capability, and combinations thereof.

15. The system of claim 3, wherein the pod further comprises a coupling mechanism for attaching the pod to a device selected from an incubator, culture vessel, support surface, additional pods, additional control units, and combinations thereof.

16. The system of claim 3, wherein the incubator further comprises a coupling mechanism for receiving the pod.

17. The system of claim 1, wherein the control unit is a data transmission device having wireless capability, hardwired capability and combinations thereof.

18. The system of claim 3, wherein the management control unit is adapted to cause a cell culture process operation to be carried on the basis of the determination of the culture state of the cells from the acquired images.

19. The system of claim 18, wherein the cell culture process operations includes one or more of the following:
i) controlling levels of media and nutrients in the culture device,
ii) sampling, lifting, and recovering the cells from the culture device.
iii) splitting and plating cells into additional culture devices

20. The system of claim 18, wherein the cell culture process operation includes controlling the level of a cell culture process condition selected from pH, lactic acid, glucose, oxygen, nitrogen, glutamine, carbon dioxide, ammonia, temperature, pressure, humidity, and combinations thereof.

21. The system of claim 5, wherein the management control unit is adapted to determine in real time the culture state of the cells from the images acquired by the cameras.

22. The system of claim 1, wherein the management control unit is adapted to determine the culture state of the cells in real time from data acquired by a sensor from the group of a pH sensor, temperature sensor, humidity sensor, pressure sensor, glucose sensor, oxygen sensor, carbon dioxide sensor, glutamine sensor, lactic acid sensor, ammonia sensor, nitrogen sensor, spectroscopy sensor, and combinations thereof.
